(19) United States
(12) Patent Application Publication
(10) Pub. No.: US 2021/0280089 A1
(43) Pub. Date: Sep. 9, 2021

(54) Pop-Up Three-Dimensional Tri-Folded All Occasional Greeting Cards

(71) Applicant: Isriel McBride, JR., Richmond, TX (US)

(72) Inventor: Isriel McBride, JR., Richmond, TX (US)

(21) Appl. No.: 17/151,653

(22) Filed: Jan. 18, 2021

(51) Int. Cl. G09F 1/06

(52) U.S. Cl. CPC G09F 1/06

(57) ABSTRACT

The Invention is a Pop-Up Three-Dimensional Tri-Folded All Occasional Greeting Card, which is a light to medium cardstock. It can be of oval or in other setting surrounding the image. The middle leaves are heart shaped with the other leaves coming off of that heart shaped leaf. The design consists of a variation of hybrid roses along with birds and butterflies, but not limited to those image designs. All images can be in color or black and white.

Lightweight to medium Cardstock™ card triple folded into a 3-dimensional image for all occasion greeting cards. The intended use for the Pop-Up Three-Dimensional Tri-Folded All Occasional Greeting Cards is to share an inspirational card to family and friends.

### FIGURE DESCRIPTIONS

We will use Lightweight to medium cardstock. The card is triple folded into a tri-folded card opening from left to right, with a cut-out image on the first fold and a mirror shadow image of the second fold being any image that is mirrored to that image. The final fold has a cut-out image of the first image to make the pop-up. The first image and shadow mirrored image are in an oval or other setting surrounding the image. The leaves are heart shaped, with the other leaves coming off the middle heart shaped leaf. The height dimensions are 7¾″ or larger and the length dimensions are 11¼″ or larger. The card is tripled folded to equal, 3¾″ in sizes. All images are in color or black and white. The designs consist of a variation of hybrid roses along with birds and butterflies but not limited to those designs. A cut-out image of the identical color image of the first fold is used to create a three-dimensional effect. Two of the bottom three leaves are used to make the pop-up.

### POP-UP DESCRIPTION

The bottom three leaves are used to make the pop-up. The first leaf of the bottom three leaves is folded ¼″ and attached (adhered) to the edge of the second fold at the bottom shadow leaf image. The third leaf across from the shadow image is folded outward ½ of the leaf. This leaf is across from the 1st attachment. ⅛ of the leaf tip is attached (adhered) to the wall of the third fold. The pop-up attachment is just parallel to the rose outer edge. Whereas the card is open, the pop-up is displayed creating a three-dimensional pop-up that is in a variety of patterns, colors, and sayings.

### DRAWING

I, Isriel McBride Jr. have designed a triple folded three-dimensional pop-up greeting card. It is of lightweight to medium cardstock, that open from left to right. It can be in an oval or other setting designs surrounding the image. The middle leaves are heart shaped with the other leaves coming off of that heart shaped leaf. The designs consist of a variation of hybrid roses along with birds and butterflies but not limited to those image designs. All images can be in color or black and white.

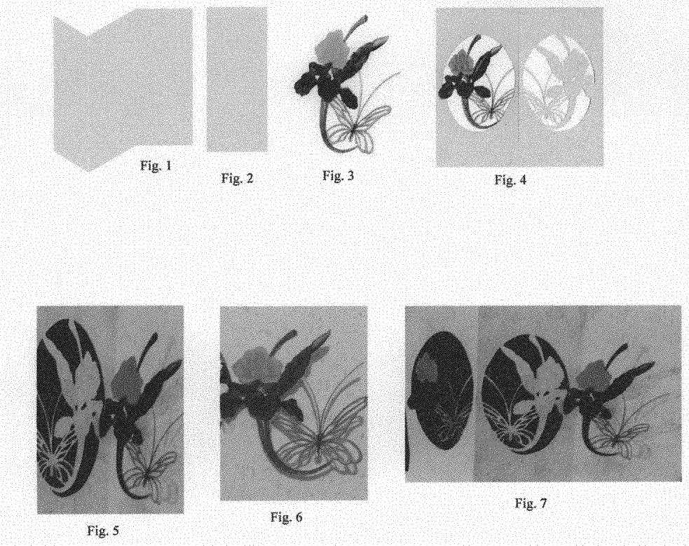

FIG. 1 The height dimensions are 7¾″ or larger and the length is 11¼″ or larger.

FIG. 2 The card is triple folded to equal 3¾″ in sizes.

FIG. 3 A cut out image identical to the image on the card first fold is used to create the pop-up effect of the greeting card.

FIG. 4 The first fold image is cut-out with a mirror shadow image of that image being any image that is identical to that image.

FIG. 5 Two of the bottom three leaves are used to make the pop-up effect. The first leaf end is folded ¼″ downward and attached (with adhesive) to the edge of the bottom second fold shadow leaf edge.

FIG. 6 The third leaf is folded outward ¼″ of the leaf edge. The tip of the third leaf is attached (with adhesive) ¼″ to the third fold wall. It is parallel to the rose outer edge. Whereas, when the card is open the pop-up is displayed in a three-dimensional effect.

FIG. 7 The triple folded three-dimensional pop-up card is displayed

I claim: the ornamental design for the Pop-Up Three-Dimensional Tri-Folded All Occasional Greeting Card as shown and described.

### SUMMARY OF INVENTION

The Invention is a Pop-Up Three-Dimensional Tri-Folded All Occasional Greeting Cards.

1. I claim the ornamental design for the Pop-Up Three-Dimensional Tri-Folded All Occasional Greeting Cards as shown and described.
